(19) United States
(12) Patent Application Publication
(10) Pub. No.: US 2024/0385142 A1
(43) Pub. Date: Nov. 21, 2024

(54) ULTRASOUND TRANSDUCER ELEMENT CONTINUITY TEST VISUALIZATION

(71) Applicant: Exo Imaging, Inc., Redwood City, CA (US)

(72) Inventors: Mohammad Afrough, Fremont, CA (US); Rajeev Sivadasan, San Jose, CA (US); Jed Davidow, San Francisco, CA (US); Gordon T. Sasamori, Mountain View, CA (US)

(73) Assignee: Exo Imaging, Inc., Redwood City, CA (US)

(21) Appl. No.: 18/319,706

(22) Filed: May 18, 2023

(51) Int. Cl. G01N 29/06; G01N 29/04

(52) U.S. Cl. CPC G01N 29/0654; G01N 29/043; G01N 2291/106

(57) ABSTRACT

A visualization of electrical continuity test results for a transducer tile array may be generated according to embodiments herein. The visualization may include an indication, for each channel under test, of whether the channel passed or failed the continuity test, and an indication of whether the transducer tile array is determined to be functional.

FIELD

Embodiments relate in general to the field of ultrasonic imaging devices.

### BACKGROUND

Ultrasound imaging is widely used in the field of medical imaging, for example, to image internal tissue, bones, blood flow, or organs of human or animal bodies in a non-invasive manner. To perform ultrasound imaging, an ultrasound imaging device may transmit an ultrasonic signal into the body and receive a reflected signal from the body part being imaged. Ultrasound imaging devices include transducer elements (which may be referred to as transceivers or imagers, and which may be based on photo-acoustic or ultrasonic effects) to transmit and receive the ultrasonic signals into/out of the body. The transducer elements convert the ultrasonic signals into electrical signals and vice versa. Electrical continuity to the various transducer elements is typically tested before its inclusion in an ultrasound imaging device, but the test results can typically be difficult to decipher quickly.

### SUMMARY

Embodiments herein may operate according to one or more sets of instructions, using algorithms, either collectively or individually, to generate visualizations of electrical continuity test results for ultrasound transducer tiles.

### BRIEF DESCRIPTION OF THE DRAWINGS

Some of the features of the embodiments are set forth with particularity in the appended claims. A better understanding of the features and advantages of embodiments will be obtained by reference to the following detailed description, in which the principles of the embodiments are utilized, and the accompanying drawings (also “Figure” and “Fig.” herein), of which:

FIG. 1 is a block diagram of an imaging device in accordance with disclosed embodiments.

FIG. 2 is a diagram of an imaging system in accordance with disclosed embodiments.

FIG. 3A is a schematic diagram of an imaging device in accordance with some disclosed embodiments.

FIG. 3B is a schematic diagram of internal components of the imaging device of FIG. 3A according to one embodiment.

FIG. 4 is a side view of a curved transducer array, according to an example of the principles described herein.

FIG. 5 is a top view of a transducer, according to an example of the principles described herein.

FIG. 6 illustrates an example test result format output by current testing methods for a transducer element array.

FIGS. 7A-7C illustrate various example test result visualizations that may be provided by embodiments of the present disclosure.

FIG. 8 is a flow diagram of an example process of visualizing continuity test results for a transducer tile according to one or more embodiments.

FIG. 9 illustrates an example system that may implement embodiments of the present disclosure.

### DETAILED DESCRIPTION

Ultrasound imaging devices include one or more transducer tiles that have an array of transducer elements. As described further below, the transducer tile includes a number of transmit and receive channels for sending and receiving ultrasonic signals, respectively. The transducer includes circuitry to convert electrical signals into the ultrasonic waveforms for transmit signals, and vice versa for receive signals.

Certain embodiments of the present disclosure may utilize microelectromechanical (MEMS)-based transducer elements that include either piezoelectric micromachined ultrasound transducer (pMUT) or capacitive micromachine ultrasonic transducer (cMUT) technologies. In general, MUTs, such as both cMUT and pMUT, include a diaphragm (a thin membrane attached at its edges, or at some point in the interior of the probe), whereas a “traditional” bulk lead zirconate titanate (PZT) element typically consists of a solid piece of material. However, aspects of the present disclosure may be utilized with other types of transducer technologies as well, including traditional PZT-based technologies.

Piezoelectric micromachined ultrasound transducers (pMUTs) may be efficiently formed on a substrate leveraging various semiconductor wafer manufacturing operations. Semiconductor wafers may currently come in 6 inch, 8 inch, and 12 inch sizes and are capable of housing hundreds of transducer arrays. These semiconductor wafers start as a silicon substrate on which various processing operations are performed. An example of such an operation is the formation of SiO2 layers, also known as insulating oxides. Various other operations such as the addition of metal layers to serve as interconnects and bond pads are performed to allow connection to other electronics. Yet another example of a machine operation is the etching of cavities. Compared to the conventional transducers having bulky piezoelectric material, pMUT elements built on semiconductor substrates are less bulky, are cheaper to manufacture, and have simpler and higher performance interconnection between electronics and transducers. As such, they provide greater flexibility in the operational frequency of the ultrasound imaging device using the same, and potential to generate higher quality images. Frequency response may for example be expanded though flexibility of shaping the diaphragm and its active areas with piezo material.

In some embodiments, the ultrasound imaging device includes an application specific integrated circuit (ASIC) that includes transmit drivers, sensing circuitry for received echo signals, and control circuitry to control various operations. The ASIC may be formed on the same or another semiconductor wafer. This ASIC may be placed in close proximity to pMUT or cMUT elements to reduce parasitic losses. As a specific example, the ASIC may be 50 micrometers (μm) or less away from the transducer array. In a broader example, there may be less than 100 μm separation between the 2 wafers or 2 die, where each wafer includes many dies, and a die includes a transducer array in the transducer wafer and an ASIC array in the ASIC wafer. The array may have up to 10,000 or more individual elements. In some embodiments, the ASIC has matching dimensions relative to the pMUT or cMUT array and allows the devices to be stacked for wafer-to-wafer interconnection or transducer die on ASIC wafer or transducer die to ASIC die interconnection. Alternatively, the transducer can also be developed on top of the ASIC wafer using low temperature piezo material sputtering and other low temperature processing compatible with ASIC processing.

Wherever the ASIC and the MEMS transducer interconnect, according to one embodiment, the two may have similar footprints. More specifically, according to the latter embodiment, a footprint of the ASIC may be an integer multiple or divisor of the MUT footprint.

As previously mentioned, an imaging device according to embodiments herein may include a number of transmit channels and a number of receive channels. Transmit channels are to drive the transducer elements with a voltage pulse at frequencies the elements are responsive to. This causes an ultrasonic waveform to be emitted from the elements, which waveform is to be directed towards an object to be imaged (target object), such as toward an organ or other tissue in a body. In some examples, the ultrasound imaging device with the array of transducer elements may make mechanical contact with the body using a gel in between the ultrasound imaging device and the body. The ultrasonic waveform travels towards the object, i.e., an organ, and a portion of the waveform is reflected back to the transducer elements in the form of received/reflected ultrasonic energy where the received ultrasonic energy may converted to an electrical energy within the ultrasound imaging device. The received ultrasonic energy may be processed by a number of receive channels to convert the received ultrasonic energy to signals, and the signals may be processed by other circuitry to develop an image of the object for display based on the signals.

The transmit and receive channels of the transducer element arrays are typically tested for electrical continuity before they are incorporated into an ultrasound imaging device, or may be tested after their incorporation into a device, e.g., after reliability testing, such as drop testing of the device and/or transducer array. However, current testing methods provide an output that requires additional analysis by a human and is difficult to decipher quickly. For example, the transducer element tile may be provided with a test signal (current or voltage signal), and a signal for each channel (another current or voltage signal) may be read in response. The test results may simply list this resulting signal current/voltage and may provide an indication as to whether the signal indicates an issue (e.g., a short or open channel). While helpful, this information may be in a table format that is difficult to analyze quickly, especially for a tile with a large number of transmit and/or receive channels. A quality control worker might then have to analyze the entire table to determine whether the tile can be incorporated into an ultrasound imaging device. This can introduce unneeded delays and/or costs into the manufacturing process for ultrasound imaging devices.

Accordingly, embodiments herein provide methods, and associated systems/devices for implementing such methods, of visualizing results of a continuity test, e.g., one performed on an ultrasound transducer element array. The methods and systems of the present disclosure can provide much faster test analysis, which may be, for example, up to 20× faster than current methods of analysis of such results. The methods herein can provide test results that are easier to read, allowing a person with minimal training or knowledge of the tiles to interpret the results, which in turn can allow for faster sorting of transducer element tiles in a manufacturing scenario. In addition, aspects herein can provide a simplified view of the test results that can allow for more in-depth analysis of the transducer element tile under test. For example, a user may more easily determine which channels of a transducer element tile have failed and for which reason. This can allow for a person to also quickly analyze results for a number of transducer element tiles, and potentially diagnose a larger issue in the tile manufacturing if present.

Additional aspects and advantages of some embodiments will become readily apparent to those skilled in this art from the above detailed description, wherein only illustrative embodiments are shown and described. As will be realized, some embodiments are capable of achieving other, different goals, and their several details are capable of modifications in various obvious respects, all without departing from the disclosure. Accordingly, the drawings and description are to be regarded as illustrative in nature, and not as restrictive.

In the following description, for purposes of explanation, specific details are set forth in order to provide an understanding of the disclosure. It will be apparent, however, to one skilled in the art that the disclosure may be practiced without these details. Furthermore, one skilled in the art will recognize that examples of the present disclosure, described below, may be implemented in a variety of ways, such as a process, one or more processors (processing circuitry) of a control circuitry, one or more processors (or processing circuitry) of a computing device, a system, a device, or a method on a tangible computer-readable medium.

One skilled in the art shall recognize: (1) that certain fabrication operations may optionally be performed; (2) that operations may not be limited to the specific order set forth herein; and (3) that certain operations may be performed in different orders, including being done contemporaneously, and (4) operations may involve using Artificial Intelligence.

Elements/components shown in diagrams are illustrative of exemplary embodiments and are meant to avoid obscuring the disclosure. Reference in the specification to “one example,” “preferred example,” “an example,” “examples,” “an embodiment,” “some embodiments,” or “embodiments” means that a particular feature, structure, characteristic, or function described in connection with the example is included in at least one example of the disclosure and may be in more than one example. The appearances of the phrases “in one example,” “in an example,” “in examples,” “in an embodiment,” “in some embodiments,” or “in embodiments” in various places in the specification are not necessarily all referring to the same example or examples. The terms “include,” “including,” “comprise,” and “comprising” shall be understood to be open terms and any lists that follow are examples and not meant to be limited to the listed items. Any headings used herein are for organizational purposes only and shall not be used to limit the scope of the description or the claims. Furthermore, the use of certain terms in various places in the specification is for illustration and should not be construed as limiting.

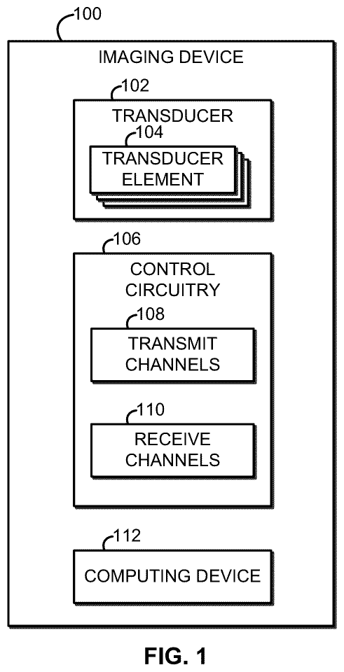

Turning now to the figures, FIG. 1 is a block diagram of an imaging device 100 in accordance with disclosed embodiments. The imaging device 100 includes a controller or control circuitry 106 that controls activation of the channels 108, 110, and further includes a computing device 112 to process signals sent to, or received from, the channels 108, 110. As described above, the ultrasound imaging device 100 may be used to generate an image of internal tissue, bones, blood flow, or organs of human or animal bodies. Accordingly, the ultrasound imaging device 100 may transmit a signal into the body and receive a reflected signal from the body part being imaged. Such imaging devices may include either pMUT or cMUT, which may be referred to as transducers or imagers, which may be based on photo-acoustic or ultrasonic effects. The ultrasound imaging device 100 may be used to image other objects as well. For example, the ultrasound imaging device may be used in medical imaging; flow measurements in pipes, speaker, and microphone arrays; lithotripsy; localized tissue heating for therapeutic; and highly intensive focused ultrasound (HIFU) surgery.

In addition to use with human patients, the ultrasound imaging device 100 may be used to acquire an image of internal organs of an animal as well. Moreover, in addition to imaging internal organs, the ultrasound imaging device 100 may also be used to determine direction and velocity of blood flow in arteries and veins as in Doppler mode imaging and may also be used to measure tissue stiffness.

The ultrasound imaging device 100 may be used to perform different types of imaging. For example, the ultrasound imaging device 100 may be used to perform one-dimensional imaging, also known as A-Scan, two-dimensional imaging, also known as B scan, three-dimensional imaging, also known as C scan, and Doppler imaging (that is, the use of Doppler ultrasound to determine movement, such as fluid flow within a vessel). The ultrasound imaging device 100 may be switched to different imaging modes, including without limitation linear mode and sector mode, and electronically configured under program control.

To facilitate such imaging, the ultrasound imaging device 100 includes one or more ultrasound transducers 102, each transducer 102 including an array of ultrasound transducer elements 104. Each ultrasound transducer element 104 may be embodied as any suitable transducer element, such as a pMUT or cMUT element. The transducer elements 104 operate to 1) generate the ultrasonic pressure waves that are to pass through the body or other mass and 2) receive reflected waves (received ultrasonic energy) off the object within the body, or other mass, to be imaged. In some examples, the ultrasound imaging device 100 may be configured to simultaneously transmit and receive ultrasonic waveforms or ultrasonic pressure waves (pressure waves in short). For example, control circuitry 106 may be configured to control certain transducer elements 104 to send pressure waves toward the target object being imaged while other transducer elements 104, at the same time, receive the pressure waves/ultrasonic energy reflected from the target object, and generate electrical charges based on the same in response to the received waves/received ultrasonic energy/received energy.

In some examples, each transducer element 104 may be configured to transmit or receive signals at a certain frequency and bandwidth associated with a center frequency, as well as, optionally, at additional center frequencies and bandwidths. Such multi-frequency transducer elements 104 may be referred to as multi-modal elements 104 and can expand the bandwidth of the ultrasound imaging device 100. The transducer element 104 may be able to emit or receive signals at any suitable center frequency, such as about 0.1 to about 100 megahertz. The transducer element 104 may be configured to emit or receive signals at one or more center frequencies in the range from about 0.1 to about 100 megahertz.

To generate the pressure waves, the ultrasound imaging device 100 may include a number of transmit (Tx) channels 108 and a number of receive (Rx) channels 110. The transmit channels 108 may include a number of components that drive the transducer 102, i.e., the array of transducer elements 104, with a voltage pulse at a frequency that they are responsive to. This causes an ultrasonic waveform to be emitted from the transducer elements 104 towards an object to be imaged.

According to some embodiments, an ultrasonic waveform may include one or more ultrasonic pressure waves transmitted from one or more corresponding transducer elements of the ultrasound imaging device substantially simultaneously. The ultrasonic waveform travels towards the object to be imaged and a portion of the waveform is reflected back to the transducer 102, which converts it to an electrical energy through a piezoelectric effect. The receive channels 110 collect electrical energy thus obtained, and process it, and send it for example to the computing device 112, which develops or generates an image that may be displayed.

In some examples, while the number of transmit channels 108 and receive channels 110 in the ultrasound imaging device 100 may remain constant, and the number of transducer elements 104 that they are coupled to may vary. A coupling of the transmit and receive channels to the transducer elements may be, in one embodiment, controlled by control circuitry 106. In some examples, for example as shown in FIG. 1, the control circuitry may include the transmit channels 108 and the receive channels 110. For example, the transducer elements 104 of a transducer 102 may be formed into a two-dimensional spatial array with N columns and M rows. In a specific example, the two-dimensional array of transducer elements 104 may have 128 columns and 32 rows. In this example, the ultrasound imaging device 100 may have up to 128 transmit channels 108 and up to 128 receive channels 110. In this example, each transmit channel 108 and receive channel 110 may be coupled to multiple or single pixels. For example, depending on the imaging mode (for example, whether a linear mode where a number of transducers transmit ultrasound waves in a same spatial direction, or a sector mode, where a number of transducers transmit ultrasound waves in different spatial directions), each column of transducer elements 104 may be coupled to a single transmit channel 108 and a single receive channel (110). In this example, the transmit channel 108 and receive channel 110 may receive composite signals, which composite signals combine signals received at each transducer element 104 within the respective column. In another example, i.e., during a different imaging mode, each transducer element 104 may be coupled to its dedicated transmit channel 108 and its dedicated receive channel 110. In some embodiments, a transducer element 104 may be coupled to both a transmit channel 108 and a receive channel 110. For example, a transducer element 104 may be adapted to create and transmit an ultrasound pulse and then detect the echo of that pulse in the form of converting the reflected ultrasonic energy into electrical energy.

The control circuitry 106 may be embodied as any circuit or circuits configured to perform the functions described herein. For example, the control circuitry 106 may be embodied as or otherwise include an application specific integrated circuit (ASIC), a field programmable gate array (FPGA), a system-on-a-chip, a processor and memory, a voltage source, a current source, one or more amplifiers, one or more digital-to-analog converters, one or more analog-to-digital converters, etc.

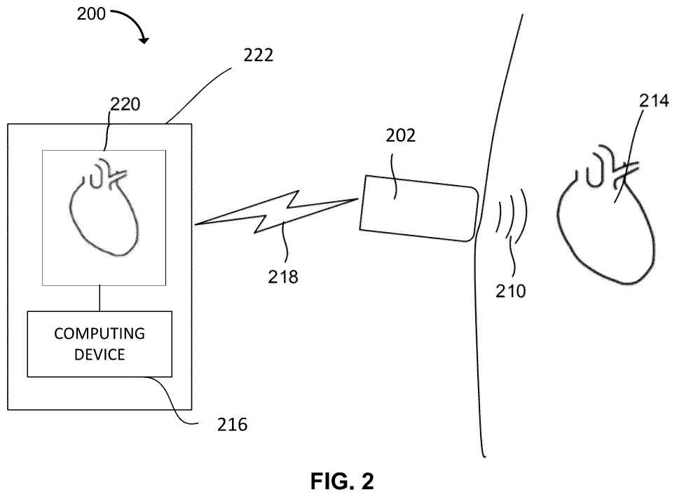

The illustrative computing device 112 may be embodied as any suitable computing device including any suitable components, such as one or more processors (i.e. one or more processing circuitries), one or more memory circuitries, one or more communication circuitries, one or more batteries, one or more displays, etc. In one embodiment, the computing device 112 may be integrated with the control circuitry 106, transducers 102, etc., into a single microelectronic package or single chip, or a single system on a chip (SoC), or a single ultrasound imaging device housing as suggested for example in the embodiment of FIG. 1. In other embodiments, some or all of the computing devices may be in a separate microelectronic package from the control circuitry, or in a separate device distinct from the ultrasound imaging device such as an ultrasound imaging probe, as suggested for example in the embodiment of in FIG. 2 as will be described in further detail below.

Each transducer element may have any suitable shape such as, square, rectangle, ellipse, or circle. The transducer elements may be arranged in a two-dimensional array arranged in orthogonal directions, such as in N columns and M rows as noted herein or may be arranged in an asymmetric (or staggered) rectilinear array.

Transducer elements 104 may have associated transmit driver circuits of associated transmit channels, and low noise amplifiers of associated receive channels. Thus, a transmit channel may include transmit drivers, and a receive channel may include one or more low noise amplifiers. For example, although not explicitly shown, the transmit and receive channels may each include multiplexing and address control circuitry to enable specific transducer elements and sets of transducer elements to be activated, deactivated or put in low power mode. It is understood that transducers may be arranged in patterns other than orthogonal rows and columns, such as in a circular fashion, or in other patterns based on the ranges of ultrasonic waveforms to be generated therefrom.

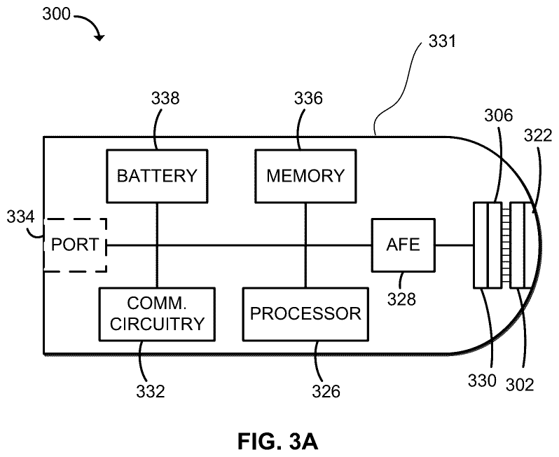

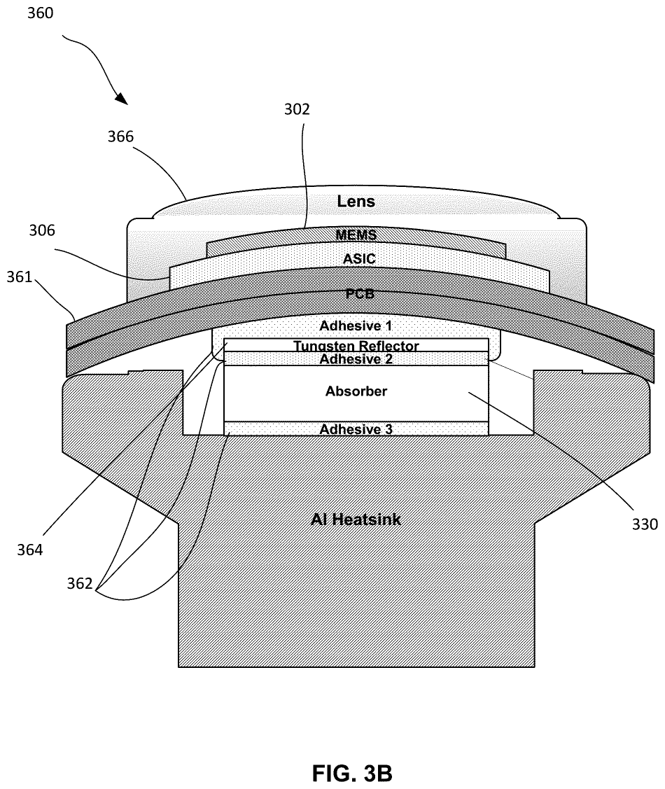

FIG. 2 is a diagram of an imaging environment including an imaging system 200 according to an embodiment. The imaging system of FIG. 2 may include an ultrasound imaging device 202 (which may be similar to ultrasound imaging device 300 described below in the context of FIG. 3) and a computing system 222 which includes a computing device 216 and a display 220 coupled to the computing device, as will be described in further detail below.

As depicted in FIG. 2, the computing device 216 may, according to one embodiment, and unlike the embodiment of FIG. 1, be physically separate from the ultrasound imaging device 220. For example, the computing device 216 and display device 220 may be disposed within a separate device (in this context, the shown computing system 222, physically separate from imaging device 202 during operation) as compared with the components of the ultrasound imaging device 202. The computing system 222 may include a mobile device, such as cell phone or tablet, or a stationary computing device, which can display images to a user. In another example, as shown in FIG. 1 for example, the display device, the computing device, and associated display, may be part of the ultrasound imaging device 202 (now shown). That is, the ultrasound imaging device 100, computing device 216, and display device 220 may be disposed within a single housing.

A “computing device” as referred to herein may, in some embodiments, be configured to generate signals to at least one of cause an image of the object to be displayed on a display, or cause information regarding the image to be communicated to a user. Further, a “computing device,” as referred to herein may, in some embodiments, be configured to receive sensor signals from sensor circuitry of an ultrasound imaging device, and to process those sensor signals to cause generation of execution signals to cause execution of ultrasound exam functions based on the sensor signals.

As depicted, the imaging system includes the ultrasound imaging device 202 that is configured to generate and transmit, via the transmit channels (FIG. 1, 108), pressure waves 210 toward an object, such as a heart 214, in a transmit mode/process. The internal organ, or other object to be imaged, may reflect a portion of the pressure waves 210 toward the ultrasound imaging device 202 which may receive, via a transducer (such as transducer 102 of FIG. 1), receive channels (FIG. 1, 110), control circuitry (FIG. 1, 106), the reflected pressure waves. The transducer may generate an electrical signal based on the received ultrasonic energy in a receive mode/process. A transmit mode or receive mode may be applicable in the context of imaging devices that may be configured to either transmit or receive, but at different times. However, as noted previously, some imaging devices according to embodiments may be adapted to be in both a transmit mode and a receive mode simultaneously. The system also includes a computing device 216 that is to communicate with the ultrasound imaging device 100 through a communication channel, such as a wireless communication channel 218 as shown, although embodiments also encompass within their scope wired communication between a computing system and imaging device. The ultrasound imaging device 100 may communicate signals to the computing device 216 which may have one or more processors to process the received signals to complete formation of an image of the object. A display device 220 of the computing system 222 may then display images of the object using the signals from the computing device.

An imaging device according to some embodiments may include a portable device, and/or a handheld device that is adapted to communicate signals through a communication channel, either wirelessly (using a wireless communication protocol, such as an IEEE 802.11 or Wi-Fi protocol, a Bluetooth protocol, including Bluetooth Low Energy, a mmWave communication protocol, or any other wireless communication protocol as would be within the knowledge of a skilled person) or via a wired connection such as a cable (such as USB2, USB 3, USB 3.1, and USB-C) or such as interconnects on a microelectronic device, with the computing device. In the case of a tethered or wired, connection, the ultrasound imaging device may include a port for receiving a cable connection of a cable that is to communicate with the computing device. In the case of a wireless connection, the ultrasound imaging device 100 may include a wireless transceiver to communicate with the computing device 216.

It should be appreciated that, in various embodiments, different aspects of the disclosure may be performed in different components. For example, in one embodiment, the ultrasound imaging device may include circuitry (such as the channels) to cause ultrasound waveforms to be sent and received through its transducers, while the computing device may be adapted to control such circuitry to the generate ultrasound waveforms at the transducer elements of the ultrasound imaging device using voltage signals, and further a processing of the received ultrasonic energy.

FIGS. 3A and 3B represent, respectively, views of an imaging device and of internal components within the housing of an imaging device according to some embodiments, as will be described in further detail below.

FIG. 3A is a schematic diagram of an imaging device 300 according to some embodiments. The imaging device 300 may be similar to imaging device 100 of FIG. 1, or to imaging device 202 of FIG. 2, by way of example only. As described above, the imaging device may include an ultrasonic medical probe. FIG. 3A depicts transducer(s) 302 of the imaging device 300. As described above, the transducer(s) 302 may include arrays of transducer elements (e.g., 104 of FIG. 1) that are adapted to transmit and receive pressure waves (e.g., 210 of FIG. 2). In some examples, the imaging device 300 may include a coating layer 322 that serves as an impedance matching interface between the transducers 302 and the human body, or other mass or tissue through which the pressure waves (e.g., 210 of FIG. 2) are transmitted. In some cases, the coating layer 322 may serve as a lens when designed with the curvature consistent with focal length desired.

The imaging device 300 may be embodied in any suitable form factor. In some embodiments, part of the imaging device 300 that includes the transducers 302 may extend outward from the rest of the imaging device 100. The imaging device 300 may be embodied as any suitable ultrasonic medical probe, such as a convex array probe, a micro-convex array probe, a linear array probe, an endovaginal probe, endorectal probe, a surgical probe, an intraoperative probe, etc. In some embodiments, the user may apply gel on the skin of a living body before a direct contact with the coating layer 322 so that the impedance matching at the interface between the coating layer 322 and the human body may be improved. Impedance matching may reduce the loss of the pressure waves at the interface and the loss of the reflected wave travelling toward the imaging device 300 at the interface. In some examples, the coating layer 322 may be a flat layer to maximize transmission of acoustic signals from the transducer(s) 102 to the body and vice versa. The thickness of the coating layer 322 may be a quarter wavelength of the pressure wave (e.g., 210 of FIG. 2) to be generated at the transducer(s) 102.

The imaging device 300 also includes a control circuitry 306, such as one or more processors (e.g., in the form of an application-specific integrated circuit (ASIC chip or ASIC)) for controlling the transducers 302 (which may be implemented in the same or similar manner as transducers 102 of FIG. 1). The control circuitry 306 may be implemented in the same or similar manner as the control circuitry 106 of FIG. 1, and may be electrically connected to the transducers 302, e.g., by way of bumps or other similar types of electrical connectors. As described herein, the electrical connections to the transducers may be tested prior to their incorporation in the device 300 to ensure that the resulting imaging device 300 functions properly. The transducers 302 may be tested according to one or more of the methods described herein.

The imaging device 300 may also include one or more processors 326 for controlling the components of the imaging device 300. One or more processors 326 may be configured to, in addition to control circuitry 306, at least one of control an activation of transducer elements, process electrical signals based on reflected ultrasonic waveforms from the transducer elements or generate signals to cause a restoration of an image of an object being imaged by one or more processors of a computing device, such as computing device 112 of FIG. 1 or 216 of FIG. 2. One or more processors 326 may further be adapted to perform other processing functions associated with the imaging device. The one or more processors 326 may be embodied as any type of processors 326. For example, the one or more processors 326 may be embodied as a single or multi-core processor(s), a single or multi-socket processor, a digital signal processor, a graphics processor, a neural network compute engine, an image processor, a microcontroller, a field programmable gate array (FPGA), or other processor or processing/controlling circuit. The imaging device 100 may also include circuit(s) 328, such as Analog Front End (AFE), for processing/conditioning signals, and an acoustic absorber layer 330 for absorbing waves that are generated by the transducers 102 and propagated towards the circuits 328. That is, the transducer(s) 102 may be mounted on a substrate and may be attached to an acoustic absorber layer 330. This layer absorbs any ultrasonic signals that are emitted in the reverse direction (i.e., in a direction away from coating layer 322 in a direction toward port 334), which may otherwise be reflected and interfere with the quality of the image. While FIG. 3A depicts the acoustic absorber layer 330, this component may be omitted in cases where other components prevent a material transmission of ultrasound in the reverse direction. The analog front end 328 may be embodied as any circuit or circuits configured to interface with the control circuitry 306 and other components of the imaging device, such as the processor 326. For example, the analog front end 328 may include, e.g., one or more digital-to-analog converters, one or more analog-to-digital converters, one or more amplifiers, etc.

The imaging device may include a communication unit 332 for communicating data, including control signals, with an external device, such as the computing device (FIG. 2, 216), through for example a port 334 or a wireless transceiver. The imaging device 100 may include memory 336 for storing data. The memory 336 may be embodied as any type of volatile or non-volatile memory or data storage capable of performing the functions described herein. In operation, the memory 336 may store various data and software used during operation of the imaging device 100 such as operating systems, applications, programs, libraries, and drivers.

In some examples, the imaging device 100 may include a battery 338 for providing electrical power to the components of the imaging device 100. The selectable alteration of the channels may have a particularly relevant impact when the imaging device 100 includes a battery 338. For example, as the receive channels (e.g., 110 of FIG. 1) and transmit channels (e.g., 108 of FIG. 1) include components that draw power, the battery depletes over time. The consumption of power by these components in some examples may be rather large such that the battery 338 would drain in a short amount of time. This is particularly relevant when obtaining high quality images which consume significant amounts of power. The battery 338 may also include battery charging circuits which may be wireless or wired charging circuits (not shown). The imaging device may include a gauge that indicates a battery charge consumed and is used to configure the imaging device to optimize power management for improved battery life. Additionally or alternatively, in some embodiments, the imaging device may be powered by an external power source, such as by plugging the imaging device into a wall outlet.

Referring now to FIG. 3B, a more detailed view is shown of the internal components 360 within the housing of the imaging device 300 of FIG. 3A, minus the coating layer 322. The front portion 360 may, in the shown example of FIG. 3B, include a lens 366, below which lies a microelectromechanical (MEMs)-based transducer(s) 302, coupled to an ASIC 306 as shown. The ASIC 306 may represent an example of the control circuitry 306 of FIG. 3A. The ASIC 306 is in turn coupled to a printed circuit board (PCB) 361, which may include some or all electronic components of the imaging device 300 shown in FIG. 3A, such as the battery 338, memory 336, communication circuitry 332 and/or processor 326, along with AFE 328 and port 334 of FIG. 3A. The assembly including the lens 366, transducer(s) 302, ASIC 306 and PCB 360 may rest on a series of layers including one or more adhesive layers 362, an absorber 330, and a reflector 364 (e.g., a tungsten reflector as shown).

It should be appreciated that, in some embodiments, various components of the imaging device as shown in FIGS. 3A and 3B may be omitted from an imaging device, or may be included in other components separate from the imaging device. For example, in one embodiment, the one or more processors 326 may include some or all of the control circuitry 106. Additionally or alternatively, some or all of the components may be integrated into or form part of a system-on-a-chip (SoC) or multichip package.

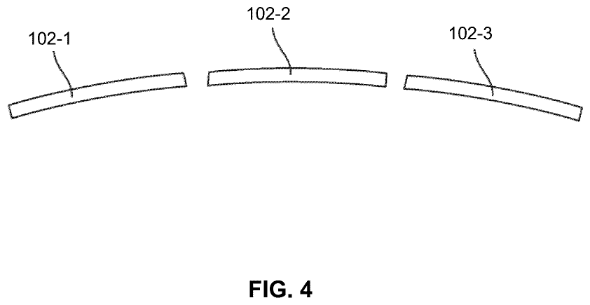

FIG. 4 is a side view of a transducer array 102, according to an example of the principles described herein. As described above, the imaging device (FIG. 1, 100) may include an array of transducers 102-1, 102-2, 102-3, each with their own array of transducer elements (FIG. 1, 104). In some examples, the transducers 102 may be curved (as suggested for example in FIG. 3B) so as to provide a wider angle of the object (FIG. 2, 214) to be imaged.

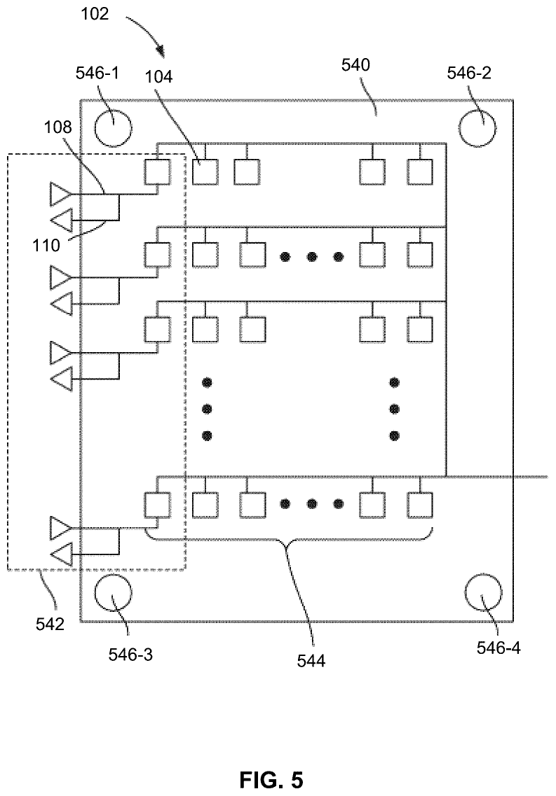

FIG. 5 depicts a top view of a single transducer 102. As depicted in FIG. 5, the transducer 102 may include a transceiver substrate 540 and one or more transducer elements 104 arranged thereon. Unlike the conventional systems that use bulk transducer elements, the transducer element 104 may be formed on a wafer and the wafer may be diced to form multiple transducers 102. This process may reduce the manufacturing cost since the transducers 102 may be fabricated in high volume and at low cost.

In some examples, the diameter of the wafer may range between 8˜12 inches and many transducer element 104 arrays may be batch manufactured thereon. Furthermore, in some examples, the control circuitry (e.g., 106 of FIG. 1) for controlling the transducer elements 104 may be formed such that each transducer element 104 is connected to the matching integrated circuits, e.g., receive channels (e.g., 108 of FIG. 1) and transmit channels (e.g., 106 of FIG. 1) in close proximity, preferably within 25 pm-100 pm. For example, the transducer 102 may have 1024 transducer elements 104 and be connected to a matching control circuitry (e.g., 106 of FIG. 1) that has the appropriate number of transmit and receive circuits for the 1,024 transducer elements 104.

A transducer element 104 may have any suitable shape such as, square, rectangle, ellipse, or circle. As depicted in FIG. 5, in some examples, the transducer elements 104 may be arranged in a two-dimensional array arranged in orthogonal directions. That is, the transducer element 104 array may be an M×N array with N columns 542 and M rows 544. Other examples may orient the transducer elements 104 in a different pattern, such as a three-dimensional array.

To create a line element, a column 542 of N transducer elements 104 may be connected electrically in parallel. Then, this line element may provide transmission and reception of ultrasonic signals similar to those achieved by a continuous transducer element that is almost N times longer than each transducer element 104. This line element may be called a column or line or line element interchangeably. An example of a column of piezo element is shown in FIG. 5 by the reference number 542. Transducer elements 104 are arranged in a column 542 in this example and have associated transmit driver circuits (part of transmit channel) and low noise amplifiers which are part of the receive channel circuitry.

Although not explicitly shown, the transmit and receive circuitry may include multiplexing and address control circuitry to enable specific elements and sets of elements to be used. It is understood that transducers 102 may be arranged in other shape such as circular, or other shapes. In some examples, each transducer elements 104 may be spaced 250 pm from each other center to center.

In the transducer 102 of the present specification, it is advantageous to design a line element using a plurality of identical transducer elements 104, where each element may have its characteristic center frequency. When a plurality of the transducer elements 104 are connected together, the composite structure (i.e., the line element) may act as one line element with a center frequency that consists of the center frequencies of all the element pixels. In modern semiconductor processes, these center frequencies match well to each other and have a very small deviation from the center frequency of the line element it is also possible to mix several pixels of somewhat different center frequencies to create a wide bandwidth line compared to lines using only one central frequency.

In some examples, the transducers 102 may include one or more temperature sensors 546-1, 546-2, 546-3, 546-4 to measure the temperature of the transducer 102. While FIG. 5 depicts temperature sensors 546 disposed at particular locations, the temperature sensors 546 may be disposed at other locations on the transducer 102 and additional sensors may be disposed at other locations on the imaging device (e.g., 100 of FIG. 1).

FIG. 5 also depicts the terminals of the transducer elements 104. That is, each transducer element 104 may have two terminals. A first terminal may be a common terminal shared by all transducer elements 104 in the array. The second terminal may connect the transducer elements 104 to the transmit channels (e.g., 108 of FIG. 1) and receive channels (e.g., 110 of FIG. 1). This second terminal may be the terminal that is driven and sensed for every transducer element 104 as shown symbolically for those transducer elements 104 in the first column. For simplicity, the second terminal is only indicated for those transducer elements 104 in the first column. However, similar terminals with the associated transmit channels 108 and receive channels 110 populate the other transducer elements 104 in the array. The control circuitry (e.g., 106 of FIG. 1) using control signals can select a column 542 of transducer elements 104 by turning on respective transmit channels (e.g., 108 of FIG. 1) and receive channels (e.g., 110 of FIG. 1) and turning off the channels in other columns 542. In a similar manner, it is also possible to turn off particular rows, or even individual, transducer elements 104.

As described above, the transmit and receive channels of the transducer element arrays may be tested for electrical continuity before they are incorporated into an ultrasound imaging device. However, current testing methods provide an output that requires additional analysis by a human and is difficult to decipher quickly.

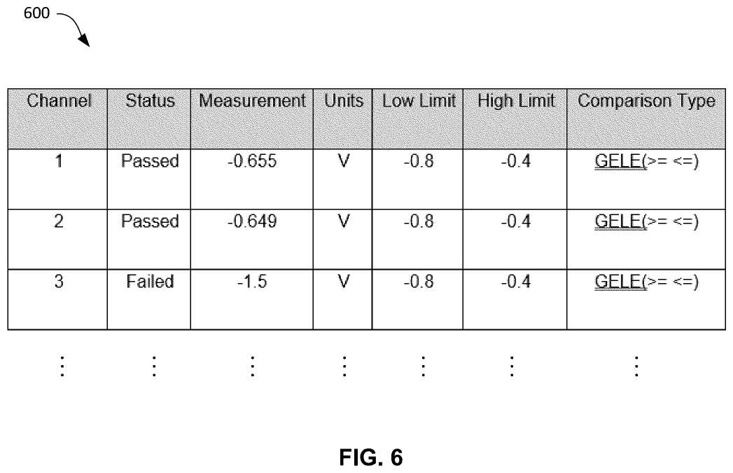

FIG. 6 illustrates an example test result format output by current testing methods for a transducer element array. In the example shown, the test results include continuity tests performed on each channel of a transducer tile that includes a transducer element array. Each channel may represent an electrical connection (e.g., pad or bump) that connects a transducer tile (e.g., a MEMS-based transducer such as 302 on an ASIC such as 306, as shown in FIG. 3B) with a PCB (e.g., PCB 361 of FIG. 3B) in an ultrasound imaging device.

The example test results are provided in a table 600 that includes a first column indicating the channel under test, a second column indicating whether the channel passed or failed, a third column indicating an electrical measurement for the channel (Volts in the example shown) obtained from the test, a fourth column indicating the units for the measurement in the third column, a fifth column indicating a lower limit for a passing result, a sixth column indicating an upper limit for a passing result, and a seventh column indicating a comparison type for determining whether the channel has passed or failed the test. The comparison type shown is a GELE (>=<=) comparison in which the measurement of the third column is compared with the lower and upper limits in the fifth and sixth columns, respectively, and the test result is considered passing if the measurement is greater than the lower limit and also less than the upper limit. The result may be generated in this format or another type of format (e.g., a raw format such as a comma-separated output (e.g., a .csv file) or text-only format (e.g., a .txt file)) for a large number of channels in a transducer element array, which would make the test results very difficult to quickly analyze for failures or other issues. Thus, embodiments herein provide techniques for visualizing test results such as those shown in FIG. 6 so that they may be analyzed and deciphered quickly by a manufacturer.

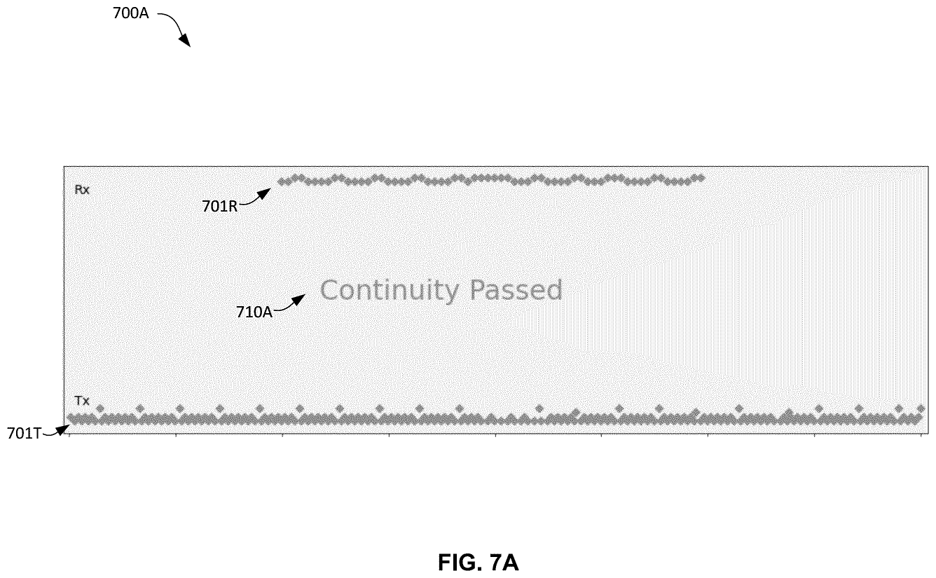

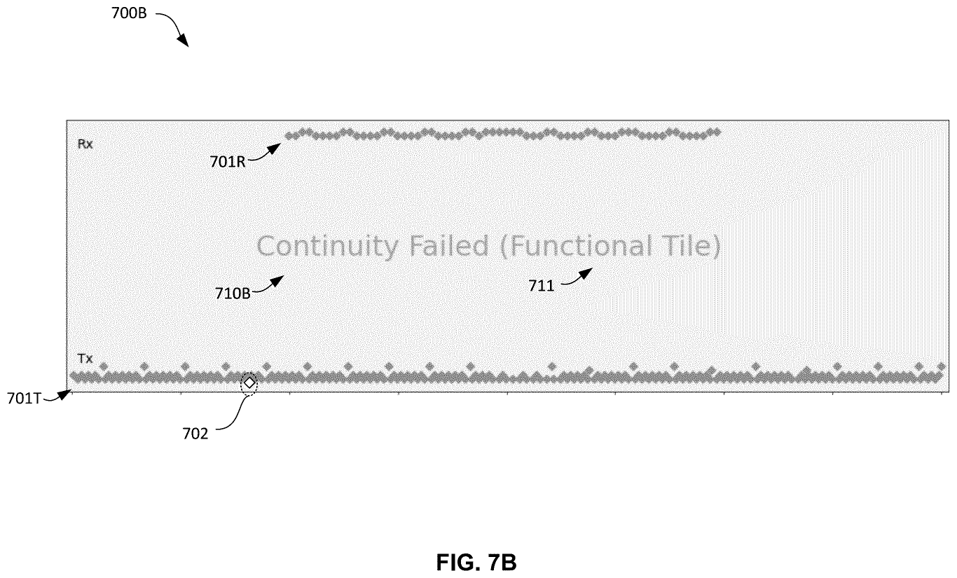

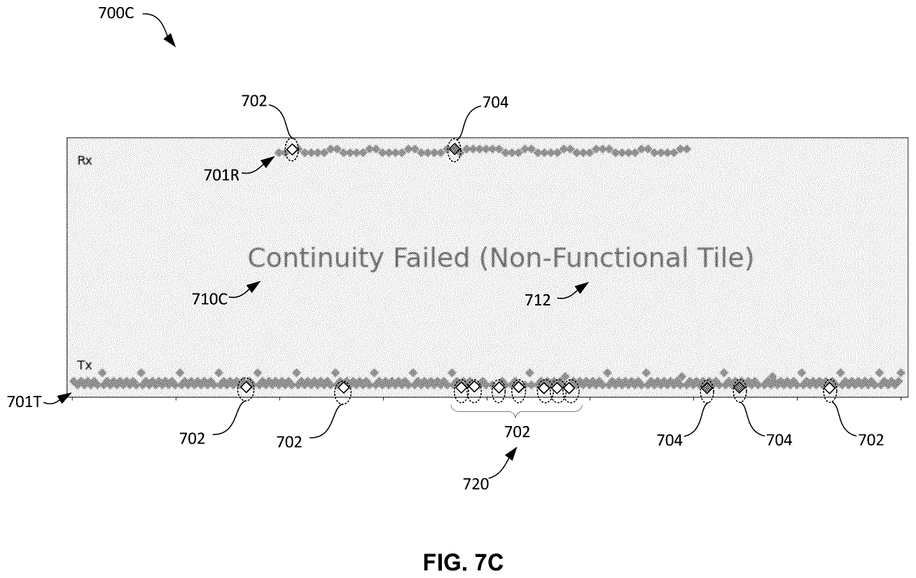

FIGS. 7A-7C illustrate various example test result visualizations 700 that may be provided by embodiments of the present disclosure. The visualizations shown may be generated from test results for a transducer element array (which may also be referred to as a transducer tile) in a format that is similar to, or the same as, those shown in FIG. 6. In the examples shown, a transducer under test includes 128 transmit channels and 64 receive channels. The results for the transmit channels are indicated by the plot points 701T, and the results for the receive channels are indicated by the plot points 701R. As shown, the results for the transmit and receive channels may be shown separately so that they may be analyzed separately from one another. In the example shown, the plot points 701T and 701R are visualized in the same plot for each tile; however, in other embodiments, the plot points 701T and 701R may be visualized in separate plots for each tile.

In the example visualization 700A shown in FIG. 7A, every channel under test has passed and the visualization includes a visual statement 710A that indicates the transducer tile under test has passed and may be incorporated into an ultrasound imaging device such as those described above. As will be recognized, the indication provided by the visual statement 710A is clear and fast for any person that is trying to interpret the test results, and particularly, much faster than analyzing each line of a table format such as that shown in FIG. 6. Further, as will be recognized with the examples of failed channels in the visualizations 700B, 700C of FIGS. 7B. 7C, the visualizations may also provide a way for a tester to more easily notice patterns of failures in the tiles. For instance, a tester may more easily notice a cluster of failures (e.g., 720). Moreover, a tester can (and will in practice) analyze a number of such visualizations and can more easily make inferences to determine if there is a pattern of failures that might indicate a wider spread manufacturing issue (e.g., a particular area or cluster of many tiles with the same continuity issues).

Turning to the example visualization 700B shown in FIG. 7B, the example visualization includes a visual statement 710B indicates that the continuity test has failed while another visual statement 711 indicates that the tile is a functional tile that can be incorporated into an ultrasound imaging device. The continuity test has failed in this example because of the open circuit result point 702 (indicated by an open diamond plot point vs. the solid plot points for passing results) in the transmit channel plot points 701T. However, the tile may be considered as functional for incorporation into an ultrasound imaging device because of one or more reasons that will be explained further below (e.g., because the number of channel failures is less than a threshold and/or because the channel is not considered a “critical” channel).

Turning to the example visualization 700C shown in FIG. 7C, the example visualization includes a visual statement 710C indicates that the continuity test has failed and another visual statement 712 that indicates that the tile is a non-functional tile, i.e., it cannot be incorporated into an ultrasound imaging device. The continuity test has failed in this example because of the open circuit result points 702 as well as the short circuit result points 704 (indicated by a cross-hatched lot point vs. the open plot point for open circuit results and the solid plot points for passing results). Open circuit results and short circuit results may be determined based on the measurements in the test results, e.g., those shown in FIG. 6. For example, a measurement may be determined to be a short circuit result if a voltage measurement is approximately 0 V (e.g., less than +/−0.001 V), and a measurement may be determined to be an open circuit result if a voltage measurement is approximately a rail voltage (e.g., +/−1.5 V in certain embodiments). A tile under test may be considered as non-functional for one or more reasons that will be explained further below (e.g., the cluster 720 of open channels in the transmit channels and/or a number of failed channels over a threshold and/or one or more critical channels not having continuity).

The passing indication provided by a visual statement such as 710A in FIG. 7A may be included because each channel has passed its electrical continuity test, e.g., the voltage obtained by the test was within the lower and upper limits prescribed for the channel (see, e.g., the limits indicated in the table 600 of FIG. 6 and the results that indicate a “PASS” in the fifth column). Where continuity tests have passed for each channel in the tile, the tile may be considered as functional, i.e., it can be incorporated into an ultrasound imaging device.

However, a tile can also be considered as a functional tile where it has one or more failed channel continuity tests. For example, a tile can be considered functional if it has a total number of failed channels that is below a threshold number of failed channels (e.g., 5, 10, or 20 failed channels), assuming that none of the failed channels are short circuit results or critical channels. As used herein, a critical channel may refer to a channel that must have continuity for the transducer tile to be incorporated into an ultrasound imaging device. A short circuit result for any channel may be considered as a non-functional channel due to issues it might cause with circuitry connected to the tile in the ultrasound imaging device if it were to be included therein. However, in other instances, a short circuit result might not be dispositive for indicating whether a tile is considered functional or non-functional.

In some embodiments, there may be a threshold number for all channels in the tile and additionally, thresholds for the number of failed channels within either the transmit or receive channels. For instance, if the total failure threshold described above is set to 10, but a device has 8 receive channel failures, it may be considered as non-functional, e.g., where the threshold for failures in the transmit and receive channels is 5.

As yet another example, a tile can be considered functional if it does not have a cluster of failures (e.g., the cluster 720 shown in FIG. 7C). A cluster may refer to a particular number (e.g., a threshold) of failed channel results that are in proximity with one another. For example, a cluster of failed may refer to at least 3 failed channels (e.g., those with open and/or short circuit results) within 6 adjacent channels, or a similar analysis. This may be problematic as compared with a tile with 3 overall failures that are more spread out because the clustering can cause blind spots in the imaging provided by the ultrasound imaging device. For similar reasoning, a tile may be considered as non-functional if it has certain clusters of nearby transmit and receive channels that are failed. For instance, if adjacent or corresponding transmit/receive channels have failed, then the tile may be considered as non-functional as it may lead to blind spots in the imaging.

Conversely, a tile may be considered as non-functional if it has one or more of, for example: a failed result in a critical channel, a short circuit in a channel, a total number of failed channels over a threshold (e.g., over 5, 10, or 20 failed channels), a total number of transmit channels over a threshold, a total number of receive channels over a threshold, a cluster of failed channels in either the transmit and/or receive channels.

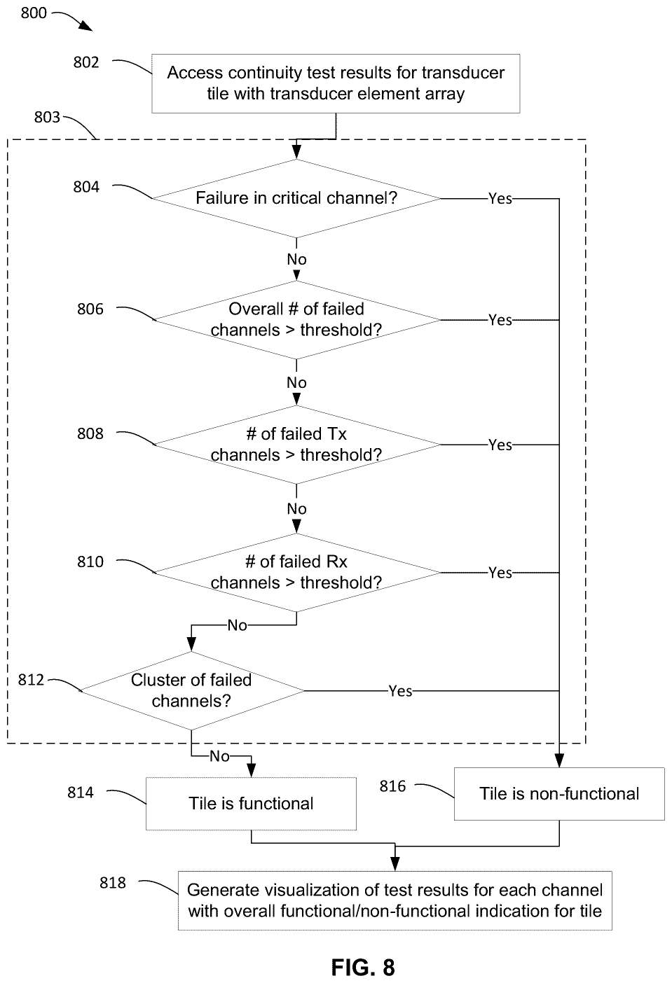

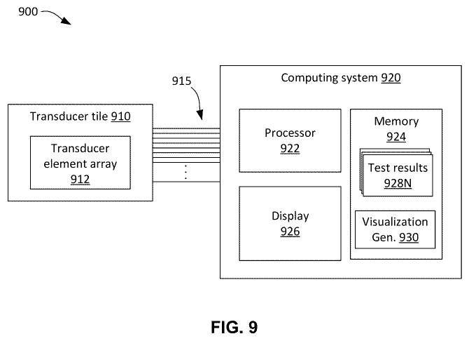

FIG. 8 is a flow diagram of an example process 800 of visualizing continuity test results for a transducer tile according to one or more embodiments. The example process 800 can be performed by one or more components of an apparatus (such as any part of, including one or more processors of) a computing device or computing system (e.g., that shown in FIG. 9 and described further below) according to some embodiments. In some embodiments, one or more aspects of the example process 800 are embodied as instructions in a computer-readable medium that, when executed by a machine (e.g., a processor of a computing device) cause the machine to implement the operations described below.

At operation 802, a set of continuity test results for a transducer tile with a transducer element array is accessed. The test results may be results of a continuity test performed on each of the channels of the transducer tile. The results may be in any suitable format output by a testing unit, and may include, for each channel, a current or voltage obtained from the continuity test on the channel along with an upper and lower threshold for passing (i.e., where a test result value would need to be between the upper and lower threshold values to pass). An example format is described above with respect to FIG. 6. In some embodiments, the results may be in a raw data format, e.g., a text file, such as a comma-separated format. In other embodiments, the results may be in a table format, such as the format shown in FIG. 6.

At operation 803, a set of operations is performed to determine, based on the test results accessed at 802, whether the transducer tile is functional or non-functional. In the example shown, this includes: the operation 804, which determines whether there is a failure in a critical channel of the transducer tile; the operation 806, which determines whether the total number of failed channels in the test results is greater than a threshold value; the operation 808, which determines whether the number of failed transmit channels is greater than a threshold value; the operation 810, which determines whether the number of failed receive channels is greater than a threshold value; and the operation 812, which determines whether there is a cluster of failed channels in the transducer tile. If any of these determinations is true, then the tile may be considered as non-functional at 816. Otherwise, the tile may be considered as functional at operation 814.

Then, at operation 818, a visualization of the test results is generated along with an indication of whether the tile was determined to be functional or non-functional. FIGS. 7A-7C illustrate example visualizations that may be generated at 818; however, other types of visualizations may be generated at 818 as well. The visualizations may indicate, for each channel, whether the channel passed or failed the continuity test. In addition, in some instances, the visualization may, for failed test results, indicate a type of failure (e.g., short or open circuit). Further, the visualization may include separate visualizations for the transmit vs. receive channels of the transducer tile. For instance, the visualization may include plots points for each channel that indicate the pass/fail determination. The visualization may include two sets of plot points, e.g., as shown in FIGS. 7A-7C: one for the transmit channels and one of the receive channels. The separate plots points may be on different or the same plots (e.g., on the same plot as shown in FIGS. 7A-7C).

As stated, the visualization generated at 818 may include some indication of whether the tile is functional or non-functional. The indication may be included in the visualization as a statement, e.g., as shown in FIGS. 7A-7C. For instance, the indication may include statements as to both (1) whether the tile passed the continuity test (e.g., “continuity test passed” where all channels passed, and “continuity test failed” where one or more channels failed the continuity test; and (2) whether the tile was determined to be functional or non-functional. Examples of this are shown in FIGS. 7A-7C.

In other embodiments, the indication of functional/non-functional may be included in the visualization in another manner. For example, there may be a color-based indication of the functional/non-functional determination. For instance, as background color of the chart may be green for a tile determined to be functional, and may be yellow, orange, or red for a tile determined to be non-functional. In this way, a tester may quick decipher whether the tile can be incorporated into an ultrasound imaging device or must be scrapped, recycled, etc.

FIG. 9 illustrates an example system 900 that may implement embodiments of the present disclosure. The example system 900 includes a transducer tile 910 that includes a transducer element array 912 and a computing system 920 that is connected to the transducer tile 910. The transducer element array 912 may be implemented similar to the array shown in FIG. 5 and described above. The computing system 920 includes a processor 922, memory 924, a display 926. The memory 924 includes test results 928 for a number N of transducer tiles and a visualization generation application 930. The application 930 includes a set of instructions to generate visualizations in accordance with embodiments herein. The instructions can include programs, codes, scripts, or other types of data stored in memory. However, in some instances, the instructions can be wholly or partially encoded as pre-programmed or re-programmable logic circuits, logic gates, or other types of hardware or firmware components in the system 900. The display 926 may be any suitable means for displaying information output by the computing system 920 (e.g., output by the processor 922). For instance, the display may be a liquid crystal display (LCD), organic light emitting diode (OLED)-based display, or another type of display suitable for computing systems.

The processor 922 executes instructions, for example, the instructions of the visualization generation application 930. The processor 922 may be or include a general-purpose microprocessor, as a specialized co-processor or another type of data processing apparatus. In some cases, the processor 922 may be configured to execute or interpret software, scripts, programs, functions, executables, or other instructions stored in the computing system 920. In some instances, the processor 922 includes multiple processors or data processing apparatuses. The memory 924 includes one or more computer-readable media. For example, the memory 924 may include a volatile memory device, a non-volatile memory device, or a combination thereof. The memory 924 can include one or more read-only memory devices, random-access memory devices, buffer memory devices, or a combination of these and other types of memory devices. The memory 924 may store instructions (e.g., programs, codes, scripts, or other types of executable instructions) that are executable by the processor 922 (e.g., application code for the visualization generation application 930).

In operation, the computing system 920 may generate test signals (e.g., voltage or current signals) for each of the channels and transmit the test signals to the transducer tile 910 over an interface 915. The interface 915 may include electrical connections between the computing system 920 and each channel of the transducer tile 910, as shown. The computing system 920 may receive signals back from each channel, and may store those signals as test results in the memory 924 as shown. The test results 928 may be formatted as described above. The computing system 920 may then execute, via the processor 922, the visualization generation application 930 to generate a visualization (e.g., the visualization shown in FIGS. 7A-7C) based on the test results 928. The computing system 920 may store the visualizations (e.g., the charts, plots, etc. output by the visualization generation application 930) in the set of test results 928, e.g., along with the corresponding raw data. Additionally or alternatively, the computing system 920 may display the visualization on the display 926. A tester may then use the displayed visualization to determine whether to incorporate the transducer tile in an ultrasound imaging device, or to scrap/recycle the transducer tile instead.

Aspects of the present disclosure have been described with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

While preferred embodiments of the present disclosure have been shown and described herein, it will be obvious to those skilled in the art that such embodiments are provided by way of example only. It is not intended that embodiments be limited by the specific examples provided within the specification. While embodiments of the disclosure have been described with reference to the aforementioned specification, the descriptions and illustrations of the embodiments herein are not meant to be construed in a limiting sense. Numerous variations, changes, and substitutions will now occur to those skilled in the art without departing from the concepts of the present disclosure. Furthermore, it shall be understood that all aspects of the various embodiments are not limited to the specific depictions, configurations, or relative proportions set forth herein, which depend upon a variety of conditions and variables. It should be understood that various alternatives to the embodiments described herein may be employed. It is therefore contemplated that the disclosure also covers any such alternatives, modifications, variations or equivalents.

### EXAMPLES

Illustrative examples of the technologies disclosed herein are provided below. An embodiment of the technologies may include any one or more, and any combination of, the examples described below.

Example 1 is a method comprising accessing a set of electrical continuity test results for a transducer tile array, the test results comprising, for each channel of the transducer tile array, an electrical signal response of the channel in response to a test signal; determining, for each channel, whether the channel passed its electrical continuity test based on a comparison of the electrical signal response of the channel with an expected response for the channel; determining, based on the pass or fail determinations for each channel, whether the transducer tile array is functional; and generating a visualization of the electrical continuity test results, comprising: an indication, for each channel under test, of whether the channel passed or failed the continuity test; and an indication of whether the transducer tile array is determined to be functional.

Example 2 includes the subject matter of Example 1, wherein the visualization comprises an indication that a channel failed, the indication the channel failed comprising an indication of the type of failure.

Example 3 includes the subject matter of Example 1 or 2, wherein determining whether the transducer tile array is functional comprises determining whether a channel of the transducer tile array determined to have failed the electrical continuity test is a critical channel for the transducer tile array.

Example 4 includes the subject matter of any one of Examples 1-3, wherein determining whether the transducer tile array is functional comprises determining whether a number of channels of the transducer tile array determined to have failed the electrical continuity test is greater than a first threshold value.

Example 5 includes the subject matter of any one of Examples 1-4, wherein determining whether the transducer tile array is functional comprises determining whether a number of transmit channels of the transducer tile array determined to have failed the electrical continuity test is greater than a second threshold value.

Example 6 includes the subject matter of any one of Examples 1-5, wherein determining whether the transducer tile array is functional comprises determining whether a number of receive channels of the transducer tile array determined to have failed the electrical continuity test is greater than a third threshold value.

Example 7 includes the subject matter of any one of Examples 1-6, wherein determining whether the transducer tile array is functional comprises determining whether a cluster of channels of the transducer tile array have been determined to have failed.

Example 8 includes the subject matter of Example 7, wherein determining whether a cluster of channels of the transducer tile array have failed comprises determining whether a set of channels of the transducer tile array determined to have failed the electrical continuity test are within a threshold number of adjacent channels.

Example 9 includes the subject matter of any one of Examples 1-8, wherein the visualization comprises a chart with plot points for each channel.

Example 10 includes the subject matter of Example 9, wherein the chart comprises a first set of plot points for the transmit channels of the transducer tile array and a second set of plot points for the receive channels of the transducer tile array, the first and second set of plot points separated from each other in the visualization.

Example 11 includes the subject matter of any one of Examples 1-10, wherein the visualization includes a visual statement indicating whether all of the electrical continuity tests passed for each channel of the transducer tile array.

Example 12 includes the subject matter of any one of Examples 1-11, wherein the visualization includes a visual statement indicating whether the transducer tile array was determined to be functional.

Example 13 includes the subject matter of any one of Examples 1-12, wherein the visualization includes a color-coded indication of whether the transducer tile array was determined to be functional.

Example 14 is one or more computer-readable media comprising instructions that, when executed by a processor, perform the operations of any one of Examples 1-13.

Example 15 is a system comprising: a memory storing instructions; and processor circuitry to execute a set of instructions to implement the method of any one of Examples 1-13.

Example 16 includes an apparatus comprising means for performing the method of any one of Examples 1-13.

Example 17 includes one or more computer-readable media comprising a plurality of instructions stored thereon that, when executed, cause one or more processors to perform the method of any one of Examples 1-13

Example 18 is a product comprising one or more tangible computer-readable non-transitory storage media comprising computer-executable instructions operable to, when executed by at least one computer processor, enable the at least one processor to perform the method of any one of Examples 1-13.

What is claimed is:

1. A method comprising:
accessing a set of electrical continuity test results for a transducer tile array, the test results comprising, for each channel of the transducer tile array, an electrical signal response of the channel in response to a test signal;
determining, for each channel, whether the channel passed its electrical continuity test based on a comparison of the electrical signal response of the channel with an expected response for the channel;
determining, based on the pass or fail determinations for each channel, whether the transducer tile array is functional; and
generating a visualization of the electrical continuity test results, comprising:
an indication, for each channel under test, of whether the channel passed or failed the continuity test; and
an indication of whether the transducer tile array is determined to be functional.

2. The method of claim 1, wherein the visualization comprises an indication that a channel failed, the indication the channel failed comprising an indication of the type of failure.

3. The method of claim 1, wherein determining whether the transducer tile array is functional comprises determining whether a channel of the transducer tile array determined to have failed the electrical continuity test is a critical channel for the transducer tile array.

4. The method of claim 1, wherein determining whether the transducer tile array is functional comprises determining whether a number of channels of the transducer tile array determined to have failed the electrical continuity test is greater than a first threshold value.

5. The method of claim 1, wherein determining whether the transducer tile array is functional comprises determining whether a number of transmit channels of the transducer tile array determined to have failed the electrical continuity test is greater than a second threshold value.

6. The method of claim 1, wherein determining whether the transducer tile array is functional comprises determining whether a number of receive channels of the transducer tile array determined to have failed the electrical continuity test is greater than a third threshold value.

7. The method of claim 1, wherein determining whether the transducer tile array is functional comprises determining whether a cluster of channels of the transducer tile array have been determined to have failed.

8. The method of claim 7, wherein determining whether a cluster of channels of the transducer tile array have failed comprises determining whether a set of channels of the transducer tile array determined to have failed the electrical continuity test are within a threshold number of adjacent channels.

9. The method of claim 1, wherein the visualization comprises a chart with plot points for each channel.

10. The method of claim 9, wherein the chart comprises a first set of plot points for the transmit channels of the transducer tile array and a second set of plot points for the receive channels of the transducer tile array, the first and second set of plot points separated from each other in the visualization.

11. The method of claim 1, wherein the visualization includes a visual statement indicating whether all of the electrical continuity tests passed for each channel of the transducer tile array.

12. The method of claim 1, wherein the visualization includes a visual statement indicating whether the transducer tile array was determined to be functional.

13. The method of claim 1, wherein the visualization includes a color-coded indication of whether the transducer tile array was determined to be functional.

14. One or more computer-readable media comprising instructions that, when executed by one or more processors, cause the one or more processors to:
access a set of electrical continuity test results for a transducer tile array, the test results comprising, for each channel of the transducer tile array, an electrical signal response of the channel in response to a test signal;
determine, for each channel, whether the channel passed its electrical continuity test based on a comparison of the electrical signal response of the channel with an expected response for the channel;
determine, based on the pass or fail determinations for each channel, whether the transducer tile array is functional; and
generate a visualization of the electrical continuity test results, comprising:
an indication, for each channel under test, of whether the channel passed or failed the continuity test; and
an indication of whether the transducer tile array is determined to be functional.

15. The computer-readable media of claim 14, wherein determining whether the transducer tile array is functional comprises determining whether a channel of the transducer tile array determined to have failed the electrical continuity test is a critical channel for the transducer tile array.

16. The computer-readable media of claim 14, wherein determining whether the transducer tile array is functional comprises determining whether a number of channels of the transducer tile array determined to have failed the electrical continuity test is greater than a threshold value.

17. The computer-readable media of claim 14, wherein determining whether the transducer tile array is functional comprises determining whether a cluster of channels of the transducer tile array have been determined to have failed.

18. The computer-readable media of claim 14, wherein the visualization comprises a chart comprising a first set of plot points for the transmit channels of the transducer tile array and a second set of plot points for the receive channels of the transducer tile array, the first and second set of plot points separated from each other in the visualization.

19. A system comprising:
a memory storing instructions; and
processor circuitry to execute the instructions to:
access a set of electrical continuity test results for a transducer tile array, the test results comprising, for each channel of the transducer tile array, an electrical signal response of the channel in response to a test signal;
determine, for each channel, whether the channel passed its electrical continuity test based on a comparison of the electrical signal response of the channel with an expected response for the channel;
determine, based on the pass or fail determinations for each channel, whether the transducer tile array is functional; and
generate a visualization of the electrical continuity test results, comprising:
an indication, for each channel under test, of whether the channel passed or failed the continuity test; and
an indication of whether the transducer tile array is determined to be functional.

20. The system of claim 19, wherein determining whether the transducer tile array is functional comprises at least one of:
determining whether a channel of the transducer tile array determined to have failed the electrical continuity test is a critical channel for the transducer tile array;
determining whether a number of channels of the transducer tile array determined to have failed the electrical continuity test is greater than a threshold value; and
determining whether a cluster of channels of the transducer tile array have been determined to have failed.
